(19) United States
(12) Patent Application Publication
(10) Pub. No.: US 2025/0344729 A1
(43) Pub. Date: Nov. 13, 2025

(54) SYSTEM AND METHOD FOR TREATING SHRIMP AND OTHER CRUSTACEANS

(71) Applicant: John Bean Technologies Corporation, Chicago, IL (US)

(72) Inventor: Dale R. Hunt, Sandusky, OH (US)

(73) Assignee: John Bean Technologies Corporation, Chicago, IL (US)

(21) Appl. No.: 19/275,255

(22) Filed: Jul. 21, 2025

Related U.S. Application Data
(63) Continuation-in-part of application No. 18/417,551, filed on Jan. 19, 2024.
(60) Provisional application No. 63/481,147, filed on Jan. 23, 2023.
(60) Provisional application No. 63/674,727, filed on Jul. 23, 2024.

(51) Int. Cl. A23L 17/40

(52) U.S. Cl. CPC A23L 17/40

(57) ABSTRACT

A conveyance system or method for conveying a crustacean to be injected with an injection treatment solution made from water and emulsified crustacean substrate of the crustacean being treated may include a crustacean stabilizing assembly configured to substantially maintain a position of crustaceans relative to a support surface of the conveyance system before, during, and/or after injection, wherein a first pocket defined by the crustacean stabilizing assembly is positionable beneath a first injector head, the crustacean stabilizing assembly supporting crustaceans in the first pocket during injection by the first injector head, and wherein the first pocket defined by the crustacean stabilizing assembly is positionable beneath a second injector head located downsteam of the first injector head, the crustacean stabilizing assembly supporting crustaceans in the first pocket during injection by the second injector head.

### CROSS-REFERENCES TO RELATED APPLICATIONS

This application is a continuation-in-part of co-pending U.S. Provisional Application No. 18/417,551 filed on Jan. 19, 2024, which claims the benefit of U.S. Provisional Application No. 63/481,147, filed Jan. 23, 2023, the entire contents of both of which applications are incorporated herein by reference. This application also claims the benefit of U.S. Provisional Application No. 63/674,727 filed on Jul. 23, 2024, the entire contents of which application are incorporated herein by reference.

### BACKGROUND

When shrimp are commercially processed, they are subjected to a treating step prior to being packaged, frozen, or cooked, to assure that excess amounts of water are not subsequently lost. For instance, fresh seafood such as shrimp generally contains about eighty percent (80%) water. Although the major portion of this retained water is chemically bound to muscle and tissue and accordingly is not easily released, about 10 to 15 percent of the water normally is lost during processing and handling from the time of actual catch to thawing of the frozen shrimp for cooking. This water loss results in adverse changes in texture, juiciness, and appearance. This water loss also affects the shrimp yield (e.g., final weight) of the shrimp. When shrimp valued is based on its weight, water loss can significantly affect revenue.

In order to minimize this moisture loss in shrimp (whether wild or farm-raised, shell-on or off), commercial processors have employed phosphate salts, such as sodium tripolyphosphate, either alone or in combination with ordinary salt, to treat the shrimp. This is normally done by soaking the shrimp in a solution of water and phosphate salt for a given period prior to cooking or freezing. The shrimp that are to be treated are normally first peeled and deveined and soaked in the above-noted solution for a period of between, for instance, 5 hours and 24 hours. Thereafter, the treated shrimp are typically either cooked and/or frozen for later cooking.

The effect of various treating solutions on the moisture retention in shrimp is evaluated by measuring the weight of the shrimp before any treatment (the “green weight”) and then weighing them again after each processing step, namely, soaking in the treatment solution, thawing after frozen storage, and cooking, and then comparing the weights after processing with the original green weight to obtain the percent yield (e.g., percentage weight gain/loss) after each step. Before each weight is taken, the shrimp may be drained on a screen to eliminate the effect of free water. The appearance and texture evaluation of the shrimp may be judged based on visual comparison with controlled shrimp that have gone through all the same steps of the treated shrimp except, for instance, that they were either not soaked or soaked in a different solution.

Other types of crustaceans, such as lobsters and crabs, may be similarly pre-treated before subsequent processing.

### SUMMARY

In some aspects, the techniques described herein relate to a conveyance system for conveying a crustacean to be injected with an injection treatment solution made from water and emulsified crustacean substrate of the crustacean being treated, the conveyance system including: a crustacean stabilizing assembly configured to substantially maintain a position of crustaceans relative to a support surface of the conveyance system before, during, and/or after injection, wherein a first pocket defined by the crustacean stabilizing assembly is positionable beneath a first injector head, the crustacean stabilizing assembly supporting crustaceans in the first pocket during injection by the first injector head, and wherein the first pocket defined by the crustacean stabilizing assembly is positionable beneath a second injector head located downsteam of the first injector head, the crustacean stabilizing assembly supporting crustaceans in the first pocket during injection by the second injector head.

In some aspects, the techniques described herein relate to a method of injecting shrimp, including: positioning crustaceans within a first pocket of a crustacean stabilizing assembly defined on a support surface of an injector conveyance system; advancing the support surface to locate the first pocket beneath a first injector head of the injector; injecting the crustaceans positioned in the first pocket with the first injector head; advancing the support surface to locate the first pocket beneath a second injector head of the injector that is downstream of the first injector; and injecting the crustaceans positioned in the first pocket with the second injector head.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative examples, in which the principles of the invention are utilized, and the accompanying drawings of which:

FIG. 1 shows an injector having a plurality of needles supported by a carrier that are being used to inject shrimp in accordance with examples of the present disclosure.

FIG. 2 shows an example of a through-hole pattern for a conveyor belt formed in accordance with examples of the present disclosure.

FIG. 3 shows an example of a conveyor belt having a crustacean stabilizing assembly formed in accordance with examples of the present disclosure.

FIG. 4 shows a flow-chart of an example of a method for injecting shrimp in accordance with examples of the present disclosure.

FIG. 5 shows a first isometric view of an example of a conveyor belt having a crustacean stabilizing assembly formed in accordance with examples of the present disclosure.

FIG. 6 shows a second isometric view of the conveyor belt and crustacean stabilizing assembly of FIG. 5.

FIG. 7 shows a third isometric view of the conveyor belt and crustacean stabilizing assembly of FIG. 5.

### DETAILED DESCRIPTION

As noted above, untreated shrimp lose excess amounts of water during subsequent cooking operations and therefore have very poor yields. On the contrary, when soaking the shrimp in a phosphate solution, as described above, the weight gain may be about seven to nine percent (7-9%) from the soak. In that regard, soaking the shrimp in a phosphate solution is generally an effective treatment for increasing the moisture retention of the processed shrimp.

However, soaking shrimp in a phosphate solution has numerous drawbacks. For instance, soaking requires a significant amount of manual labor. Specifically, labor is needed to put the shrimp into a container, add ice and solution to the container, agitate the solution to help the shrimp pick up weight, remove the shrimp from the containers, separate the ice from the shrimp, and then place the shrimp onto a food processing line.

Soaking also requires significant real estate in a processing plant. As can be appreciated, a sufficient number of soaking tubs are needed to continually soak incoming raw shrimp for the necessary length of time, such as between 5 hours and 24 hours.

Further, while soaking shrimp in a phosphate solution does serve to reduce the loss of water, the quality of the shrimp is affected. For instance, phosphate can change the texture of the shrimp meat, resulting in a rubbery texture. Further, phosphate is not a natural ingredient; and therefore, soaking the shrimp in phosphate results in an unnatural product and must be labeled as such.

Further, soaking shrimp in a phosphate solution typically causes only moderate weight gain or “pickup”. Although various solutions and soaking times may vary the pickup percentage, generally the pickup using the soaking in phosphate solution method is no more than about seven to nine percent (7-9%).

Shrimp are categorized and packaged according to their weight, and the package value is based on the weight of the shrimp. For instance, the shrimp count on a bag of shrimp is the number that denotes how many shrimp are approximately in the bag “per pound.” If a shrimp bag's count reads “51/60,” the shrimp in that bag are sized to be approximately 51 to 60 shrimp per pound. If a shrimp bag's count reads “41/50,” the shrimp in that bag are sized to be approximately 41 to 50 shrimp per pound. The value of a 51/60 count bag may be, for instance, $8.99, whereas, the value of a 41/50 count bag may be about $10.99. Accordingly, increasing the weight of the shrimp may allow the shrimp to be categorized into a different count, possibly increasing its packaged value.

Exemplary systems and methods described herein relate to improved methods for treating shrimp and other crustaceans to address at least the above-noted issues resulting from the phosphate solution soaking method. In some aspects, the exemplary systems and methods described herein include injecting shrimp and other crustaceans (a “crustacean substrate”) with a treatment solution rather than soaking the shrimp and other crustaceans. In further aspects, the exemplary systems and methods described herein include using a high viscosity brine (HVB) or HVB injection treatment solution that includes emulsified crustacean substrate of the crustacean being treated. In yet further aspects, the exemplary systems and methods described herein include conveying the crustacean substrate beneath an injector on a conveyance system that substantially maintains the position of the crustacean substrate relative to the conveyance system as it is conveyed. These and other detailed aspects of the will become appreciated from the description that follows.

### Exemplary Systems and Methods for Injecting a Treatment Solution Into a Crustacean

As noted above, exemplary systems and methods described herein include injecting a crustacean using an HVB injection treatment solution that includes emulsified crustacean substrate of the crustacean being treated. It should be appreciated that although the exemplary systems and methods described herein will be primarily described with reference to shrimp, the exemplary systems and methods may be used for any suitable crustacean or a similar food product or substrate. Moreover, the term “HVB injection treatment solution” may be understood to include high viscosity brines, marinades, pickling solutions, etc., that may be injected. Accordingly, the descriptions and illustrations provided herein should not be seen as limiting.

As noted above, the exemplary systems and methods described herein include injecting crustacean substrates with an HVB injection treatment solution that includes emulsified crustacean substrate of the crustacean being treated. The HVB injection treatment solution of the present disclosure can be of numerous compositions or formulations, with the common component of the HVB injection treatment solution including emulsified crustacean substrate of the crustacean being treated (hereinafter sometimes simply referred to as “emulsified crustacean substrate”). The emulsified crustacean substrate may be composed primarily of the meat or muscle of the crustacean. The emulsified crustacean substrate of the crustacean being treated may be combined with water to form the HVB injection treatment solution. Other ingredients may also be included, such as salt and phosphate. Phosphate, although not necessary for achieving the effects of HVB injection disclosed herein, may be desired if a food processor wants to continue to use the same packaging/label containing the phosphate ingredient.

The HVB injection treatment solution may be made in any suitable manner, such as by using an emulsifier. For instance, the ingredients may be added to the emulsifier, and the combined ingredients may be run for a predetermined amount of time (e.g., about two minutes) through an emulsifier plate. The emulsified solution may be stored in a mixing and/or storage tank until ready to be used by an injector.

As noted above, the emulsified crustacean substrate may be mixed with water to form the HVB injection treatment solution. The water may be softened or otherwise purified or treated, for example, by reverse osmosis. In some examples, part of the water may be provided in the form of ice to result in an HVB injection treatment solution after emulsification that is below a desired temperature, such as below 0° C., or more specifically, between about −1 to −4° C. In other examples, portions of the equipment used to make the HVB injection treatment solution, such as the tank, may include insulating materials or temperature control features to substantially maintain the HVB injection treatment solution in the tank at a desired temperature. It is desirable that the HVB injection treatment solution is kept at a temperature such that it does not facilitate bacteria growth in the crustacean between injection and prior to cooking or freezing the crustacean. One way to address this will be to maintain the HVB injection treatment solution temperature below the temperature of the crustacean being treated. For instance, the temperature of the HVB injection treatment solution at the time of injection into the crustacean may be between about −1 to −4° C.

Salt can optionally be added to the HVB injection treatment solution to add or enhance flavoring and assist in retention of the HVB injection treatment solution within the crustacean substrate. The salt can be of various percentages, for example, from as low as about 0.1% to about 1% by weight of the final food product. Applicant has found that with the use of emulsified crustacean substrate in the HVB injection treatment solution, less salt is required as a flavoring agent or for the retention of the HVB injection treatment solution in the crustacean substrate.

In some examples, the percentage of at least one of emulsified crustacean substrate, water, and/or salt may be chosen depending on the desired level of salt in the finished food product (e.g., the injected crustacean after it is cooked and/or frozen). In some examples, the percentage of at least one of emulsified crustacean substrate, water, and/or salt may be chosen depending on the target yield or pickup after injection. In some examples, the percentage of at least one of emulsified crustacean substrate, water, and/or salt may be chosen depending on the target yield or pickup after the injected crustacean is cooked and/or frozen. In some examples, the percentage of at least one of emulsified crustacean substrate, water, and/or salt may be chosen depending on all of the above-mentioned factors.

In general, the percentages of each the emulsified crustacean substrate, water, and salt may be chosen to maximize yield or pickup after injection and/or after the injected crustacean is cooked and/or frozen while staying within a preferred range of the amount of salt in the finished food product and while optimizing the quality of the finished food product. For instance, if an HVB injection treatment solution has a concentration of emulsified crustacean substrate generally above a threshold level, crustaceans injected with the solution may result in a finished food product having a “glue-like” texture (or what looks like “jelly” inside the product when it is cut open). In that regard, the HVB injection treatment solution is formulated to avoid such an undesirable texture and/or appearance.

The percentages of each the emulsified crustacean substrate, water, and salt may also be chosen to optimize the viscosity of the HVB injection treatment solution for maximizing the injection process according to known injection principles. For instance, an HVB injection treatment solution having a predetermined percentage of emulsified crustacean substrate may result in an optimally viscous HVB injection treatment solution that is suitable for injecting the crustacean.

In some examples, the HVB injection treatment solution may be formulated to include between about 10-30% emulsified crustacean substrate, about 60-85% water, and about 0.1-3% salt. In some examples, the HVB injection treatment solution may be formulated to include between about 10-20% emulsified crustacean substrate, about 70-85% water, and about 0.8-2.8% salt. In some examples, the HVB injection treatment solution may be formulated to include between about 15-18% emulsified crustacean substrate, about 75-85% water, and about 2.3-2.8% salt. If phosphate is used in any of the solutions, it may be about 0.1-0.2%.

In some examples, the HVB injection treatment solution may be formulated to target an injected product having about 10-30% pickup after injection. In some examples, the HVB injection treatment solution may be formulated to target a yield to green of about 100-130%. In some examples, the HVB injection treatment solution may be formulated to target an injected product having about 15-25% pickup after injection. In some examples, the HVB injection treatment solution may be formulated to target a yield to green of about 100-115%.

Various amounts of HVB injection treatment solution as prepared using the present disclosure may be injected into a crustacean substrate. In some examples, the amount of HVB injection treatment solution (either in grams or as a percentage of the weight of the crustacean substrate) injected into a crustacean substrate may be chosen depending on the desired level of salt in the finished food product (e.g., the injected crustacean after it is cooked and/or frozen). In some examples, the amount of HVB injection treatment solution injected into a crustacean substrate may be chosen depending on the target yield or pickup after injection. In some examples, the amount of HVB injection treatment solution injected into a crustacean substrate may be chosen depending on the target yield or pickup after the injected crustacean is cooked and/or frozen. In general, the amount of HVB injection treatment solution injected into a crustacean substrate may be optimized to maximize yield or pickup after injection and/or after the injected crustacean is cooked and/or frozen while staying within a preferred range of the amount of salt in the crustacean substrate and without compromising quality.

In one example, the amount of HVB injection treatment solution injected into a crustacean substrate may be about 20% to 25% of the weight of the crustacean substrate generally provides the results being sought from the HVB injection treatment solution(s) disclosed in the present application. Of course, the amount of HVB injection treatment solution used may be beyond this range and still provide benefits including improved crustacean weight gain and texture. For instance, the amount of HVB injection treatment solution may change for smaller or larger shrimp, such as for instance, to address salt concentration or quality issues in the finished product.

Injecting shrimp with the HVB injection treatment solution in accordance with examples disclosed herein provides numerous advantages over the soaking method described above. For instance, injecting rather than soaking reduces the amount of labor and valuable real estate needed in a food processing plant. The injector has a much smaller footprint than hundreds of soaking tubs, which are necessary for continually soaking incoming shrimp. Further, the labor necessary for soaking shrimp, which includes loading/unloading the tubs, monitoring/agitating the tubs, and loading the shrimp onto an oven or freezer conveyor after soaking (which may also require removal of ice from the shrimp), is extensive. By comparison, injected shrimp may simply be loaded onto the conveyor for injection, and then (optionally automatically) moved to another conveyor (possibly in-line) for further processing.

Further, by injecting shrimp with the HVB injection treatment solution described herein, a higher yield may be achieved, allowing smaller shrimp to be moved into a higher weight, higher value category. In other words, an initially downgraded raw product can be upgraded in value, knowing that it will have a higher yield after injection. Further, the higher yield may be achieved without using any artificial ingredients, supporting an “all natural” label. Moreover, by eliminating the need for phosphate, a higher quality product can be achieved. As noted above, the use of phosphate can lead to a rubbery texture. The inventors have found that using the HVB injection treatment solution described herein provides a higher quality product compared to solutions using phosphate, without comprising yield.

These benefits will further become appreciated in the examples that follow.

### Example 1

Testing was performed to ascertain cook yield, freeze yield, and yield to green differences between shrimp injected with an injection treatment solution having emulsified shrimp, water, and salt and shrimp soaked in a water and salt soaking solution.

### HVB Injection Treatment Solution Formulation

The salt and water soaking solution used for the test is set forth in Table 1. The injection treatment solution having trim (emulsified shrimp meat), water, and salt is set forth in Table 2. The injection treatment solution formulation was based on a target of 25% yield after injection (e.g., adding 25% moisture to the raw material from the injection). The use of emulsified shrimp significantly increases the viscosity of the injection treatment solution. As such, in Table 2 below and elsewhere in this application, these injection treatment solutions may be identified by the designation “HVB”, which signifies high viscosity brine.

Table 2 also includes a percentage of the salt and trim in the finished individually quick frozen (IQF) HVB injected shrimp.

TABLE 1
Salt and water soaking solution

| Ingredient | % in Marinade | Lbs in Marinade |
|---|---|---|
| Water | 90.00% | 13.50 |
| Salt | 10.00% | 1.50 |
| Total | 100.00% | 15.00 |

TABLE 2
HVB Injection Formulation (target of 25% yield after injection)

| Ingredient | % in Marinade | % in Final | Lbs in Marinade |
|---|---|---|---|
| Water | 82.54% | | 82.54 |
| Salt | 2.58% | 0.50% | 2.58 |
| Trim | 14.88% | 3.50% | 14.88 |
| Total | 100.00% | | 100.00 |

### Test Procedures

### Soaking Test

The water and salt solution was mixed, and shell on shrimp were soaked for 4 hours. Following the 4-hour soak, a portion of the shelled shrimp were frozen in an Advantec Freezer to simulate an IQF production. A portion of shrimp were also cooked in a JSO oven with high steam and a short dwell time and then frozen. Data was recorded after the cook and freeze phases.

### HVB Injection Test

The HVB injection formulation for this test was mixed using an F-150 mill. The water and salt were combined in the mill, frozen trim (emulsified shrimp meat) was added, and the solution was thoroughly mixed. The raw shrimp was weighed and run through the injector on a very thin cutting board to mimic a belted machine. The shrimp were injected using an IMAX 350 HVB injector with a 102-needle manifold.

The injector settings (e.g., parameters that can be changed on injector) are set forth in Table 3 below. The first column in Table 3 indicates the strokes per minute of the injector, based on available settings of 1-9 strokes per minute (how many times the injector head goes up and down in a minute). The second column in Table 3 indicates the pressure used by the injector, in units of bar. The third column in Table 3, referencing the “stripper height”, indicates the setting on the injection head to define the gap between the bar that strips the needles out of meat and the injection bed. Here, because shrimp meat has a low profile, the stripper height is set at only 1 hole. The fourth column in Table 3, referencing the “advance”, is based on a full or partial advance of the belt beneath the injector for every time it moves, with a full advance in this case being 40 mm. Accordingly, the belt moved 20 mm every advance. The fifth column in Table 3 is the injection mode used, with the option in the case being a one-way spraying from the needles as they are moving down into the meat or a two-way spraying as the needles are moving down and also back up. The injector mode used was a two-way spraying.

TABLE 3
Injector Settings

| Strokes | Pressure | Stripper Height | Advance | Inject |
|---|---|---|---|---|
| 4 | 1.1 | 1 hole | Half | 2 Way |

### Yield Data

Tables 4-7 pertain to the use of the above HVB injection treatment solution formulations to soak or inject shrimp.

Table 4, which pertains to soaked shrimp, includes a first column providing the initial or “green” weight of the shrimp. The second column in Table 4 indicates the weight of the shrimp after soaking. The third column in Table 4 indicates the percentage of pickup after soaking, or the percent increase in weight of the soaked shrimp from the green weight. As can be seen, when soaking the shrimp using the above HVB injection treatment solution formulation of water and salt, the weight of the shrimp increased by 3.15%.

TABLE 4
Soaked Shrimp Data

| Green Wt | Soaked Wt | % Pickup |
|---|---|---|
| 2.54 | 2.62 | 3.15% |

Table 5, which pertains to injected shrimp, includes a first column providing the initial or “green” weight of the shrimp. The second column in Table 5 indicates the weight of the shrimp after injection. The third column in Table 5 indicates the percent pump or pickup after injection, or the percent increase in weight of the injected shrimp from the green weight. As can be seen, when injecting the shrimp using the above HVB injection treatment solution formulation of water, salt, and trim, the weight of the shrimp increased by 25.88%.

TABLE 5
HVB Injected Shrimp Data

| Green Wt | Injected Wt | % Pump |
|---|---|---|
| 2.056 | 2.588 | 25.88% |

Table 6, which compares IQF data for soaked shrimp and injected shrimp, includes a first column (“Raw Wt.”) providing the initial (raw) or “green” weight of the shrimp. The second column (“Soaked/Injected Wt.”) indicates the weight of the shrimp after soaking or injection. The third column (“% Pickup/Pump”) indicates the percent pickup or pump after soaking or injection, or the percent increase in weight of the soaked/injected shrimp from the green weight. The fourth column (“Freeze Wt”) indicates the weight of the shrimp after the IQF process. The fifth column (“Freeze Yield”) in Table 6 indicates the freeze yield, or the percentage of soaked/injected weight gain retained in the shrimp after freezing. The sixth column (“Yield to Green”) in Table 6 indicates the yield to green, or the percent increase in weight of the IQF soaked/injected shrimp from the green weight.

When looking at the “Difference” row in Table 6, it is noted that the soaked shrimp had a 1.03% greater freeze yield than the HVB injected shrimp. However, the inventors note that this result is somewhat expected because the HVB injected shrimp had a very high percentage of pump (or weight gain from the green weight); and therefore, the HVB injected shrimp had a greater amount of moisture to evaporate at the beginning of the dwell time in the freezer compared to the soaked shrimp (e.g., there is more free moisture that is lost during the IQF cycle). Table 6 also indicates, however, that the yield to green (or percent increase in weight of the soaked/injected shrimp from the green weight) for the IQF HVB injected shrimp was significantly higher at 124.32% compared to only 102.94% for the IQF soaked shrimp. In that regard, the yield to green for the HVB injected shrimp was 21.38% greater than the soaked shrimp for the IQF production, indicating much greater retention of the HVB injection treatment solution when using HVB injection.

TABLE 6
IQF Data

| | | Soaked/ | % | | | Yield |
|---|---|---|---|---|---|---|
| | Raw | Injected | Pickup/ | Freeze | Freeze | to |
| Test | Wt | Wt | Pump | Wt | Yield | Green |
| Soaked Test | 0.49 | 0.50 | 3.15% | 0.50 | 99.80% | 102.94% |
| HVB Injected | 0.39 | 0.49 | 25.87% | 0.48 | 98.77% | 124.32% |
| Test | | | | | | |
| Difference | | | | | | 21.38 |

Table 7, which compares cook and freeze (IQF) data for soaked shrimp and injected shrimp, includes a first column (“Raw Wt.”) providing the initial (raw) or “green” weight of the shrimp. The second column (“Soaked/Injected Wt.”) indicates the weight of the shrimp after soaking or injection. The third column (“% Pickup/Pump”) indicates the percent pickup or pump after soaking or injection, or the percent increase in weight of the soaked/injected shrimp from the green weight. The fourth column (Cooked Wt.) indicates the weight of the shrimp after cooking in a JSO oven. The fifth column (“Cook Yield”) indicates the cook yield, or the percentage of soaked/injected weight gain retained in the shrimp after cooking. The sixth column (“Freeze Wt”) indicates the weight of the cooked shrimp after the IQF process. The seventh column (“Freeze Yield”) indicates the freeze yield, or the percentage of weight gain retained in the cooked shrimp after freezing. The eighth column (“Yield to Green”) indicates the yield to green, or the percent increase in weight of the cooked and IQF soaked/injected shrimp from the green weight.

When looking at the “Difference” row in Table 7, it is noted that the soaked shrimp had a 15.70% greater cook yield than the HVB injected shrimp. However, the inventors note that this result is somewhat expected because the HVB injected shrimp had a very high percentage of pump (or weight gain from the green weight); and therefore, the HVB injected shrimp had a greater amount of moisture to evaporate at the beginning of the dwell time in the oven compared to the soaked shrimp (e.g., there is more free moisture that is lost during the cook cycle).

However, Table 7 also indicates that the cooked HVB injected shrimp had a 1.76% greater freeze yield compared to the cooked soaked shrimp. Further, as seen in Table 7, the cooked/IQF HVB injected shrimp had a 4.24% greater yield to green compared to the cooked/IQF soaked shrimp, indicating much greater retention of the HVB injection treatment solution when using HVB injection.

TABLE 7
Cook and Freeze Data

| | | Soaked/ | % | | | | | Yield |
|---|---|---|---|---|---|---|---|---|
| | Raw | Injected | Pickup/ | Cooked | Cooked | Freeze | Freeze | to |
| Test | Wt | Wt | Pump | Wt | Yield | Wt | Yield | Green |
| Soaked | 0.99 | 1.02 | 3.15% | 1.00 | 97.84% | 0.98 | 98.00% | 98.90% |
| Test | | | | | | | | |
| HVB | 0.79 | 0.99 | 25.88% | 0.81 | 82.14% | 0.81 | 99.75% | 103.14% |
| Injected | | | | | | | | |
| Test | | | | | | | | |
| Difference | | | | | −15.70% | | | 4.24% |

### Example 2

Testing was performed to ascertain retention (yield to green), cooked yield, and freeze yield differences between shrimp injected with an HVB injection treatment solution having emulsified shrimp, water, and salt and shrimp soaked in a water, salt, and phosphate HVB injection treatment solution.

### HVB Injection Treatment Solution Formulation

The water, salt, and phosphate soaking solution used for the test is set forth in Table 1. The injection HVB injection treatment solution having trim (emulsified shrimp), water, and salt is set forth in Table 2. The injection HVB injection treatment solution formulation was based on a target of 20% yield after injection.

TABLE 1
Water, salt and phosphate soaking solution

| Ingredient | % in Marinade | % in Final | Kgs in Marinade |
|---|---|---|---|
| Water | 94.00% | 7.76% | 65.8 |
| Salt | 4.00% | 0.33% | 2.80 |
| Phosphate | 2.00% | 0.17% | 1.40 |
| Total | 100.00% | | 70.00 |

TABLE 2
HVB Injection Formulation

| Ingredient | % in Marinade | % in Final | Kgs in Marinade |
|---|---|---|---|
| Water | 76.69% | | 53.68 |
| Salt | 2.39% | 0.40% | 1.67 |
| Trim | 20.92% | 3.50% | 14.64 |
| Total | 100.00% | | 70.00 |

### Test Procedures

### Soaking Test

The water, salt, and phosphate soaking solution was mixed, and shell on shrimp were soaked for about 3 hours. Following the 3-hour soak, a portion of the shelled shrimp (rep 1) were re-weighed at 2 hours after the end of the soak, 24 hours after the soak, and 48 hours after the soak. A portion of the shelled shrimp (rep 2) were cooked by boiling and then chilled. A portion of the shelled shrimp (rep 3) were frozen in an ice chest freezer to simulate an IQF production. It is noted that an ice chest freezer does not freeze as optimally as, for instance, an Advantec freezer, as used in Example 1, so the results may be further optimized if using an Advantec freezer or similar.

### HVB Injection Test

The HVB injection formulation for this test was mixed using an F-150 mill. The water and salt were combined in the mill, frozen trim (emulsified shrimp meat) was added, and the solution was thoroughly mixed. The raw shrimp was weighed and run through the injector. The shrimp were injected using an IMAX 350 HVB injector with a 102-needle manifold. Following the injection, the shrimp were rinsed in water quickly to wash off any excess solution on the outside of the shell.

An injector similar to the injector of Example 1 was used.

### Test Data—Fresh Shrimp (Rep 1)

As noted above, for Rep 1, a portion of the shelled shrimp were re-weighed at 2 hours after the end of the 3-hour soak, 24 hours after the 3-hour soak, and 48 hours after the 3-hour soak. Tables 3 and 4 pertain to the retention of treatment formulation for fresh shrimp after use of the above HVB injection treatment solution formulations to soak or inject shrimp.

Table 3 pertains to the retention of treatment formulation in fresh shrimp that are categorized as 31/34 count shrimp in a raw state. Table 4 pertains to the retention of treatment formulation in fresh shrimp that are categorized as 41/50 count shrimp in a raw state (i.e., shrimp lower in weight than the 31/34 count shrimp).

For both Tables 3 and 4, Column 1 (“Test”) provides the test name (1B/2B or 1C/2C). Column 2 (“Test”) provides the process used to apply the treatment formulation (soaked v. injected). Column 3 (“Source”) provides the source of the shrimp (wild v. farm-raised). Column 4 (“Green Wt.”) provides the initial or “green” weight of the shrimp. Column 5 (“Soaked/Injected Wt.”) indicates the weight of the shrimp after soaking or injection. Column 6 (“Pickup %”) indicates the percentage of pickup after soaking or injection, or the percent increase in weight of the soaked/injected shrimp from the green weight. Column 7 (“Retention 1”) indicates the weight of the soaked or injected shrimp at 2 hours after the end of the 3-hour soak. Column 8 (“% Retention”) indicates the percent retention of the weight gained from the soak or injection at 2 hours after the end of the 3-hour soak.

Column 9 (“Retention 2”) indicates the weight of the soaked or injected shrimp at 24 hours after the end of the 3-hour soak. Column 10 (“% Retention”) indicates the percent retention of the weight gained from the soak or injection at 24 hours after the end of the 3-hour soak. Column 11 (“Retention 3”) indicates the weight of the soaked or injected shrimp at 48 hours after the end of the 3-hour soak. Column 12 (“Total Retention %”) indicates the percent retention of the weight gained from the soak or injection at 48 hours after the end of the 3-hour soak, or the total retention percentage.

When looking at the data for the 31/34 count shrimp in Table 3 below, the shrimp in the soaked tests 1B and 2B picked up 6.67% and 5.33%, respectively, after the 3-hour soak, whereas the shrimp in the injection tests 1B and 2B resulted in 20.27% and 18.18% pickup, respectively. When looking at the total retention in the last column of the table, which represents the retained weight gain from the soak or injection after a 48 hour (2-day) hold, the shrimp in the injection tests 1B and 2B had a much larger retention percentage of 10.81% and 11.69% respectively, compared to the shrimp in the soaked tests 1B and 2B, which had a retention percentage of −2.67% and −1.33%, respectively (for a total retention gain difference of 13.48% and 13.02%, respectively, for the injection shrimp compared to the soaked shrimp).

When looking at the data the 41/50 count shrimp in Table 4 below, the shrimp in the soaked tests 1C and 2C picked up 9.33% and 8.00%, respectively, after the 3-hour soak, whereas the shrimp in the injection tests 1C and 2C resulted in 18.92% and 18.67% pickup, respectively. When looking at the total retention in the last column of the table, which represents the retained weight gain from the soak or injection after a 48 hour (2-day) hold, the shrimp in the injection tests 1C and 2C had a much larger retention percentage of 13.51% and 16.00% respectively, compared to the shrimp in the soaked tests 1C and 2C, which had a retention percentage of −1.33% and 2.67%, respectively (for a total retention gain difference of 14.85% and 13.33%, respectively, for the injection shrimp compared to the soaked shrimp).

TABLE 3
31/34 Count Shrimp (Tests 1B and 2B)

| | | | | Soaked/ | | | % | | % | | Total |
|---|---|---|---|---|---|---|---|---|---|---|---|
| | | | Green | Injected | Pick- | Reten- | Reten- | Reten- | Reten- | Reten- | Reten- |
| Test | Test | Source | Wt | Wt | up % | tion 1 | tion | tion 2 | tion | tion 3 | tion % |
| 1B | Soak | Farm | 1.50 | 1.60 | 6.67% | 1.50 | 0.00% | 1.48 | −1.33% | 1.46 | −2.67% |
| 1B | Inject | Farm | 1.48 | 1.78 | 20.27% | 1.68 | 13.51% | 1.66 | 12.16% | 1.64 | 10.81% |
| | | | | | | | 13.51% | | 13.50% | | 13.48% |
| 2B | Soak | Wild | 1.50 | 1.58 | 5.33% | 1.50 | 0.00 | 1.48 | −1.33% | 1.48 | −1.33% |
| 2B | Inject | Wild | 1.54 | 1.82 | 18.18% | 1.80 | 16.88% | 1.76 | 14.29% | 1.72 | 11.69% |
| | | | | | | | 16.88% | | 15.62% | | 13.02% |

TABLE 4
41/50 Count Shrimp (Tests 1C and 2C)

| | | | | Soaked/ | | | % | | % | | Total |
|---|---|---|---|---|---|---|---|---|---|---|---|
| | | | Green | Injected | Pickup | Reten- | Reten- | Reten- | Reten- | Reten- | Reten- |
| Test | Test | Source | Wt | Wt | % | tion 1 | tion | tion 2 | tion | tion 3 | tion % |
| 1C | Soak | Farm | 1.50 | 1.64 | 9.33% | 1.54 | 2.67 | 1.50 | 0.00% | 1.48 | −1.33% |
| 1C | Inject | Farm | 1.48 | 1.76 | 18.92% | 1.72 | 16.22% | 1.70 | 14.86% | 1.68 | 13.51% |
| | | | | | | | 13.55% | | 14.86% | | 14.85% |
| 2C | Soak | Wild | 1.50 | 1.62 | 8.0% | 1.54 | 2.67% | 1.54 | 2.67% | 1.54 | 2.67% |
| 2C | Inject | Wild | 1.50 | 1.78 | 18.67% | 1.80 | 20.00% | 1.76 | 17.33% | 1.74 | 16.00% |
| | | | | | | | 17.33% | | 14.67% | | 13.33% |

### Test Data—Cooked Shrimp (Rep 2)

As noted above, for Rep 2, a portion of the shelled shrimp were re-weighed after a portion of the shelled shrimp were cooked by boiling and then chilled. The weight measurements were taken after being cooked and after being chilled. Tables 5 and 6 pertain to the retention of treatment formulation for cooked shrimp and cooked/chilled shrimp after use of the above HVB injection treatment solution formulations to soak or inject shrimp.

Table 5 pertains to the retention of treatment formulation in cooked and cooked/chilled shrimp that are categorized as 31/34 count shrimp in a raw state. Table 6 pertains to the retention of treatment formulation in cooked/chilled shrimp that are categorized as 41/50 count shrimp in a raw state (i.e., shrimp lower in weight than the 31/34 count shrimp).

For both Tables 5 and 6, Column 1 (“Test”) provides the test name (1B/2B or 1C/2C). Column 2 (“Test”) provides the process used to apply the treatment formulation (soaked v. injected). Column 3 (“Source”) provides the source of the shrimp (wild v. farm-raised). Column 4 (“Green Wt.”) provides the initial or “green” weight of the shrimp. Column 5 (“Soaked/Injected Wt.”) indicates the weight of the shrimp after soaking or injection. Column 6 (“Pickup %”) indicates the percentage of pickup after soaking or injection, or the percent increase in weight of the soaked/injected shrimp from the green weight. Column 7 (“Cook Wt”) indicates the weight of the soaked or injected shrimp after being boiled. Column 8 (“Cook Yield”) indicates the percent retention of the soaked/injected weight gain after the shrimp are boiled. Column 9 (“Yield to Green”) indicates the yield to green, or the percent increase in weight of the cooked soaked/injected shrimp from the green weight. Column 10 (“Chilled Wt”) indicates the weight of the soaked or injected shrimp after being boiled and then chilled. Column 11 (“Chilled Yield to Green”) indicates the yield to green, or the percent increase in weight of the cooked and then chilled soaked/injected shrimp from the green weight.

When looking at the data for the 31/34 count shrimp in Table 5 below, the shrimp in soaked tests 1B and 2B picked up 6.67% and 8.00%, respectively. The shrimp from the injected tests 1B and 2B resulted in a 23.61% and 23.29% pickup, respectively. For both the soaked and injection tests, the shrimp were cooked for the same length of time in the same temperature water. The cook yield was higher for the soaked shrimp tests, but that can be attributed to the fact that there was less moisture in the product after the treatment and therefore less to lose in the process. However, when looking at the yield to green percentages, there was an 8.17% and 12.15% difference between the injected and soaked shrimp for tests 1B and 2B, respectively. Further, the shrimp in the soaked tests had a 94.67% and 89.33% chilled yield to green and the shrimp in the injected tests resulted in 101.39% and 101.37% chilled yield to green. Therefore, the injected shrimp resulted in a 6.72% and 12.04% greater chilled yield to green advantage over the soaked shrimp.

When looking at the data for the 41/50 count shrimp in Table 6 below, the shrimp in soaked tests 1C and 2C picked up 8.00% and 6.67%, respectively, whereas the shrimp in the injection tests resulted in a pickup of 16.46% and 22.67%, respectively. The cook yield to green percentages for the shrimp in soaked tests 1C and 2C were 93.33% and 92.00%, respectively, and the cook yield to green percentages for the shrimp in injection tests 1C and 2C resulted in 101.27% and 102.67%, respectively. Therefore, the shrimp in the injection tests had a 7.93% and 10.67% greater cook yield to green percentage, respectively. After the cook process, the shrimp were chilled down to refrigeration temperatures, the chilled yield to green percentages for the shrimp in soak tests 1C and 2C are 89.33% and 90.67%, whereas the child yield to green for the shrimp in injection tests 1C and 2C were 94.94% and 96.00%. Accordingly, the injected shrimp resulted in a 5.60% and 5.33% greater chilled yield to green advantage over the soaked shrimp.

TABLE 5
31/34 Count Shrimp (Tests 1B and 2B)

| | | | | Soaked/ | | | | | | Chilled |
|---|---|---|---|---|---|---|---|---|---|---|
| | | | Green | Injected | Pickup | Cook | Cook | Yield to | Chilled | Yield to |
| Test | Test | Source | Wt | Wt | % | Wt | Yield | Green | Wt | Green |
| 1B | Soak | Farm | 1.50 | 1.60 | 6.67% | 1.44 | 90.00% | 96.00% | 1.42 | 94.67% |
| 1B | Inject | Farm | 1.44 | 1.78 | 23.61% | 1.50 | 84.27% | 104.17% | 1.46 | 101.39% |
| | | | | | | | | 8.17% | | 6.72% |
| 2B | Soak | Wild | 1.50 | 1.62 | 8.00% | 1.4 | 86.42% | 96.00% | 1.34 | 89.33% |
| 2B | Inject | Wild | 1.46 | 1.80 | 23.29% | 1.54 | 85.56% | 105.48% | 1.48 | 101.37% |
| | | | | | | | | 12.15% | | 12.04% |

TABLE 6
41/50 Count Shrimp (Tests 1C and 2C)

| | | | | Soaked/ | | | | | | Chilled |
|---|---|---|---|---|---|---|---|---|---|---|
| | | | Green | Injected | Pickup | Cook | Cook | Yield to | Chilled | Yield to |
| Test | Test | Source | Wt | Wt | % | Wt | Yield | Green | Wt | Green |
| 1C | Soak | Farm | 1.50 | 1.62 | 8.00% | 1.40 | 86.42% | 93.33% | 1.34 | 89.33% |
| 1C | Inject | Farm | 1.58 | 1.84 | 16.46% | 1.60 | 86.96% | 101.27% | 1.50 | 94.94% |
| | | | | | | | | 7.93% | | 5.60% |
| 2C | Soak | Wild | 1.50 | 1.60 | 6.67% | 1.38 | 86.25% | 92.00% | 1.36 | 90.67% |
| 2C | Inject | Wild | 1.50 | 1.84 | 22.67% | 1.54 | 83.70% | 102.67% | 1.44 | 96.00% |
| | | | | | | | | 10.67% | | 5.33% |

### Test Data—Cooked Shrimp (Rep 3)

As noted above, for Rep 3, a portion of the shelled shrimp were re-weighed after an IQF process. Tables 7 and 8 pertain to the retention of treatment formulation for IQF shrimp after use of the above HVB injection treatment solution formulations to soak or inject shrimp.

Table 7 pertains to the retention of treatment formulation in IQF shrimp that are categorized as 31/34 count shrimp in a raw state. Table 6 pertains to the retention of treatment formulation in IQF shrimp that are categorized as 41/50 count shrimp in a raw state (i.e., shrimp lower in weight than the 31/34 count shrimp).

For both Tables 7 and 8, Column 1 (“Test”) provides the test name (1B/2B or 1C/2C). Column 2 (“Test”) provides the process used to apply the treatment formulation (soaked v. injected). Column 3 (“Source”) provides the source of the shrimp (wild v. farm-raised). Column 4 (“Green Wt.”) provides the initial or “green” weight of the shrimp. Column 5 (“Soaked/Injected Wt.”) indicates the weight of the shrimp after soaking or injection. Column 6 (“Pickup %”) indicates the percentage of pickup after soaking or injection, or the percent increase in weight of the soaked/injected shrimp from the green weight. Column 7 (“Freeze Wt”) indicates the weight of the soaked or injected shrimp after being frozen using an IQF process. Column 8 (“Freezer Yield”) indicates the percent retention of the soaked/injected weight gain after the shrimp were frozen. Column 9 (“Yield to Green”) indicates the yield to green, or the percent increase in weight of the frozen shrimp from the green weight.

When looking at the data for the 31/34 count shrimp in Table 7 below, the shrimp in soaked tests 1B and 2B both picked up 6.67%. The shrimp from the injected tests 1B and 2B resulted in a 17.57% and 21.62% pickup, respectively. The shrimp in the soaked tests 1B and 2B both had a 96.25% freezer yield, and the shrimp from the injected tests 1B and 2B resulted in a 97.70% and 98.89% freezer yield, respectively. However, when looking at the yield to green percentages, the shrimp in the injected tests 1B and 2B resulted in 114.86% and 120.27% yield to green, which was a 12.20% and 17.60% greater yield to green advantage over the soaked shrimp.

When looking at the data for the 41/50 count shrimp in Table 8 below, the shrimp in soaked tests 1B and 2B picked up 6.67% and 5.33%, respectively. The shrimp from the injected tests 1B and 2B resulted in a 18.42% and 14.67% pickup, respectively. The shrimp in the soaked tests 1B and 2B had a 96.25% and 98.73% freezer yield, respectively. and the shrimp from the injected tests 1B and 2B resulted in a 98.89% and 100.00% freezer yield, respectively. However, when looking at the yield to green percentages, the shrimp in the injected tests 1B and 2B resulted in 117.11% and 114.67% yield to green, which was a 13.11% and 10.67% greater yield to green advantage over the soaked shrimp.

TABLE 7
31/34 Count Shrimp (Tests 1B and 2B)

| | | | Green | Soaked | Pickup | Freeze | Freezer | Yield to |
|---|---|---|---|---|---|---|---|---|
| Test | Test | Source | Wt | Wt | % | Wt | Yield | Green |
| 1B | Soak | Farm | 1.50 | 1.60 | 6.67% | 1.54 | 96.25% | 102.67% |
| 1B | Inject | Farm | 1.48 | 1.74 | 17.57% | 1.70 | 97.70% | 114.86% |
| | | | | | | | | 12.20% |
| 2B | Soak | Wild | 1.50 | 1.60 | 6.67% | 1.54 | 96.25% | 102.67% |
| 2B | Inject | Wild | 1.48 | 1.80 | 21.62% | 1.78 | 98.89% | 120.27% |
| | | | | | | | | 17.60% |

TABLE 8
41/50 Count Shrimp (Tests 1C and 2C)

| | | | Green | Soaked | Pickup | Freeze | Freezer | Yield to |
|---|---|---|---|---|---|---|---|---|
| Test | Test | Source | Wt | Wt | % | Wt | Yield | Green |
| 1C | Soak | Farm | 1.50 | 1.60 | 6.67% | 1.56 | 97.50% | 104.00% |
| 1C | Inject | Farm | 1.52 | 1.80 | 18.42% | 1.78 | 98.89% | 117.11% |
| | | | | | | | | 13.11% |
| 2C | Soak | Wild | 1.50 | 1.58 | 5.33% | 1.56 | 98.73% | 104.00% |
| 2C | Inject | Wild | 1.50 | 1.72 | 14.67% | 1.72 | 100.00% | 114.67% |
| | | | | | | | | 10.67% |

### Conclusions

The retention testing, cook test, and freezer test for the 31/34 count and 41/50 count shrimp resulted in very large advantages for the injected shrimp.

Regarding the 31/34 count shrimp, the injection tests resulted in a 13.48% and 13.02% retention advantage after a 2-day hold period. When focusing on the cook test, the injection resulted in a 6.72% and 12.04% increase in the chilled yield to green after cook. Lastly, the injection tests were 12.20% and 17.60% greater yield to green for the frozen shrimp.

Regarding the 41/50 count shrimp, after the 2-day retention hold, the injection tests resulted in 14.85% and 13.33% greater retention than the soaked shrimp. Additionally, the injection test had a 5.60% and 5.33% advantage in chilled yield to green of the cooked shrimp test. Lastly, for the freeze test, the injected shrimp had a 13.11% and 10.67% greater yield to green after freeze.

Accordingly, when injecting the product with the HVB injection treatment solutions described herein, a lighter weight shrimp (e.g., 41/50 count) can likely be moved into the heavier, more expensive size range (e.g., 31/34 count).

### Exemplary Systems and Methods for Conveying Crustaceans Beneath an Injector Injecting the Crustaceans With HVB Injection Treatment Solutions Disclosed Herein

As noted above, exemplary systems and methods described herein include conveying the crustacean substrate beneath an injector on a conveyance system that substantially maintains the position of the crustacean substrate relative to the conveyance system as it is conveyed.

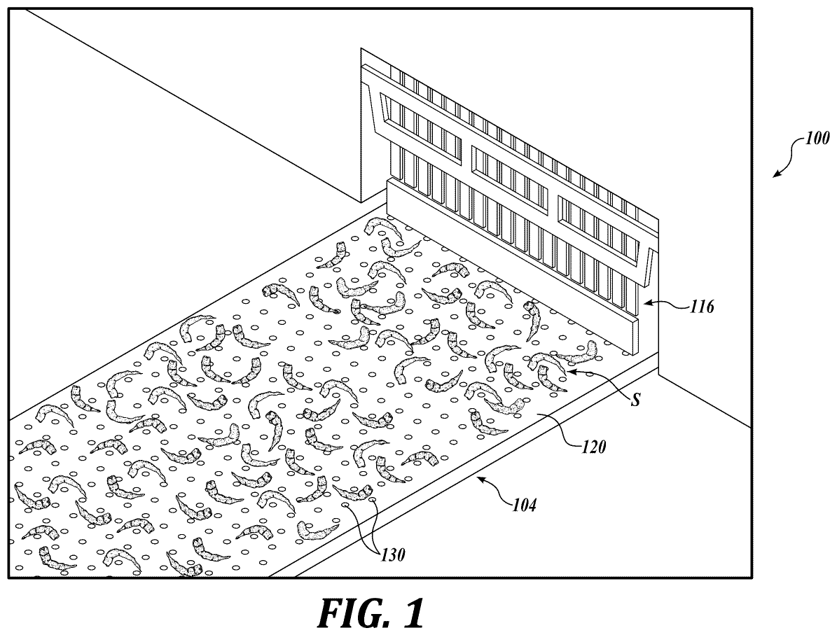

Referring to FIG. 1, injection of crustacean substrates may occur at an injection station or injector 100, which may be incorporated into a food processing line, such as a line that cooks and/or freezes the injected crustacean. The crustacean substrates may be conveyed on a conveyance system 104 of the injector 100 until they are positioned beneath a plurality of injection needles 110 supported by a carrier 116. The injector 100 may be any suitable automated or manual machine suitable for injecting crustaceans, such as shrimp S, with the HVB injection treatment solutions described herein. For instance, the injector 100 may be an IMAX injector from John Bean Technologies Corporation of Chicago, IL.

The injection needles 110 may be arranged on the carrier 116 in any suitable manner to inject the crustacean with a desired amount of HVB injection treatment solution. In the case of shrimp, the plurality of injection needles 110 may be arranged in a generally tight cross-stitched pattern suitable for penetrating the shrimp S when the shrimp are arranged in a random but generally spread-out manner on a support surface 120 of the conveyance system 104. For larger crustaceans, such as lobster, a more spaced-out cross-stitch needle arrangement may be used.

Any suitable needle design may be used. For instance, an injection needle having an elongated shank and a hypodermic exit may be used. The injection needle may have an elongated shank with an upper portion of a first diameter that is larger than a second diameter of a lower portion. In one non-limiting example, the injection needle may have an upper portion that is about three millimeters in diameter that tapers down to a lower portion that is about 2.5 millimeters in diameter.

The crustaceans are injected with HVB injection treatment solution by moving the carrier 116 down towards the support surface 120 of the conveyance system 104 until the needles 110 penetrate the crustacean substrate at a suitable depth and for a suitable length of time to allow for the HVB injection treatment solution to be dispersed into the crustacean substrate. For instance, injector settings may be used as set forth in Example 1 discussed above.

Larger crustaceans, such as lobster, may need to be penetrated from a bottom portion of the lobster. In other words, the lobsters would be positioned on the support surface 120 of the conveyance system 104 with the shell against the support surface (e.g., such that the lobster is essentially upside down). Accordingly, in some examples, the injector 100 may be configured to penetrate a lobster or similar crustacean a suitable depth without penetrating the shell on the bottom of the crustacean. For instance, the injector 100 may be configured to use less air pressure for securing the needles 110 in the injected position (e.g., 1 bar used for lobster compared to 2.5 bar used for shrimp) such that the needles would retract rather than penetrated the lobster shell.

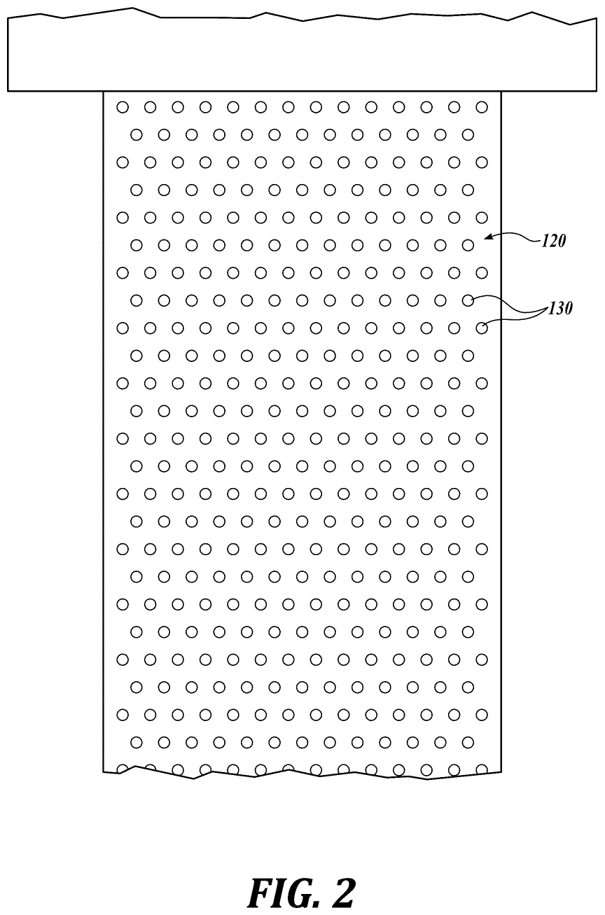

During injection, any HVB injection treatment solution that is not picked up by the crustacean will generally overflow onto the support surface 120 of the conveyance system 104. In some examples, as shown in FIGS. 1 and 2, the support surface 120 is configured as an endless conveyor belt comprised of rubber and/or plastic. In that regard, the support surface 120 will be hereinafter sometimes referred to as a “conveyor belt 120” or simply “belt 120”.

As can be appreciated from the above, the HVB injection treatment solution generally has a higher viscosity as it includes emulsified crustacean substrate. The conveyor belt 120 may include through-holes 130, as best shown FIG. 2, to allow for drainage, but with a highly viscous solution, the drainage is not likely immediate. The diameter of the through-holes 130 can be increased in size to help facilitate faster drainage, but only up until the through-hole diameter become too large to support the crustacean during injection. For instance, when injecting shrimp, larger diameter drainage holes may compromise the mechanical support of the surface beneath the shrimp needed for injection. Further, the shrimp may get caught or stuck in the larger diameter holes as they are conveyed and/or when they are injected. In that regard, at least in the case of shrimp, at least some of overflow of HVB injection treatment solution will likely remain on the belt 120 after the crustacean substrate is injection.

With a layer of HVB injection treatment solution liquid remaining on the belt 120 after the crustacean substrate is injected, the shrimp may be at least somewhat suspended in the liquid, e.g., the shrimp will sometimes float on top of the conveyor belt. As such, when the conveyor belt 120 accelerates forward, the liquid and the shrimp suspended in the liquid may not accelerate at the same rate, e.g., they may take a while to “catch up” with the belt. Moreover, when the conveyor belt 120 stops, the momentum of the liquid and the shrimp suspended in the liquid may cause the shrimp to keep moving along the surface of the belt. If a shrimp is suspended in the liquid as it is being injected, the needles may not penetrate the shrimp in the desired cross-stitched pattern defined by the injector seeing as the shrimp may move slightly relative to the belt during injection. In further aspects, errors may occur during scanning, sorting, picking, etc., if the shrimp move relative to the belt during an operational aspect of one of the steps.

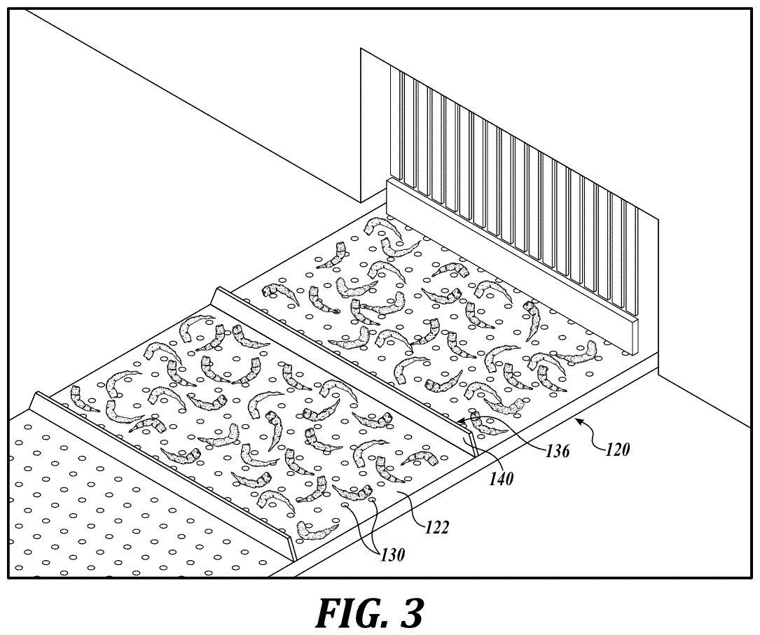

Referring to FIG. 3, the conveyor belt may include a crustacean stabilizing assembly 136 configured to substantially maintain the shrimp or other crustaceans in their position relative to the belt as it is moved. In one example, the crustacean stabilizing assembly 136 includes a plurality of substrate-stabilizing features 140 that are engageable by the suspended crustaceans as the belt 120 accelerates or stops. For instance, the substrate-stabilizing features 140 of the crustacean stabilizing assembly 136 may be defined by a plurality of protrusions, partitions, flights, lips, etc. (hereinafter simply “lips”) protruding from the top surface of the belt body 122, at least some of which are transversely arranged relative to the elongated axis of the belt 120 and spaced relative to one another.

The substrate-stabilizing features 140 may be of a suitable height, shape, contour, etc., and they may be spaced along the elongated axis of the belt 120 a suitable distance to retain a desired number of crustaceans between adjacent substrate-stabilizing features 140 as the belt moves and the crustaceans are injected. For instance, as shown in FIG. 3, the substrate-stabilizing features 140 may be a lip that extends substantially across the width of the belt 120 and extends substantially transversely upwardly from the belt upper surface to define a lip height that is substantially equal to or greater than a maximum height of crustacean when suspended in HVB injection treatment solution liquid.

The lips may be spaced apart a suitable distance to enable substantially all the carrier needles to engage crustaceans between adjacent lips. For instance, the lips may be spaced along the elongated axis of the belt 120 a suitable distance to retain a desired number of crustaceans between adjacent protrusions for a full or partial advance of the belt beneath the injector. In that regard, a head and/or needle pattern of the injector may essentially fit inside a pocket defined on the belt between adjacent lips, and the injector can inject crustaceans in the pocket every time the belt advances. In this manner, the movement of the injector head and the belt are substantially synchronized. In the example shown in FIG. 3, the lips may be spaced along the elongated axis of the belt 120 a suitable distance to retain a desired number of crustaceans between adjacent protrusions for a full advance of the belt beneath the injector.

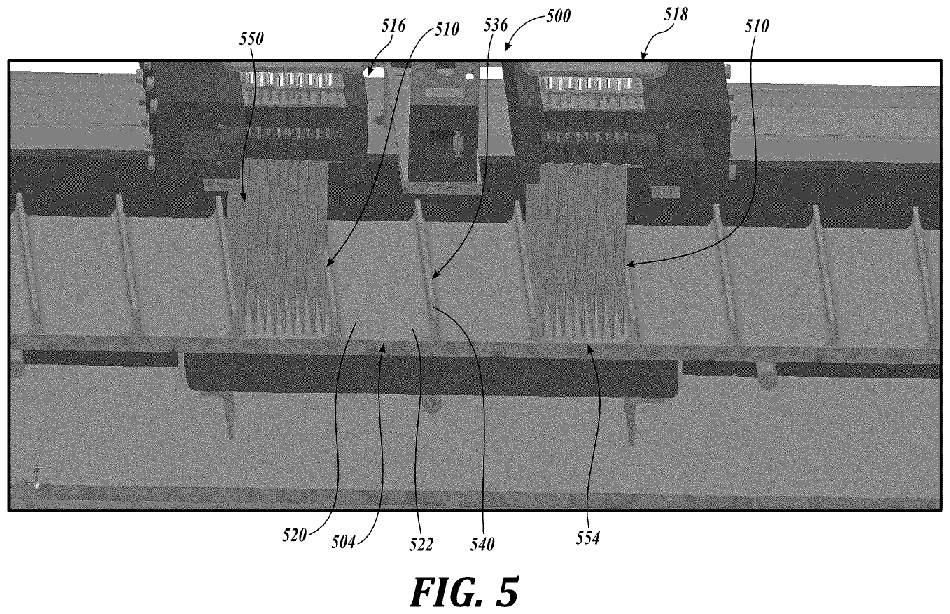

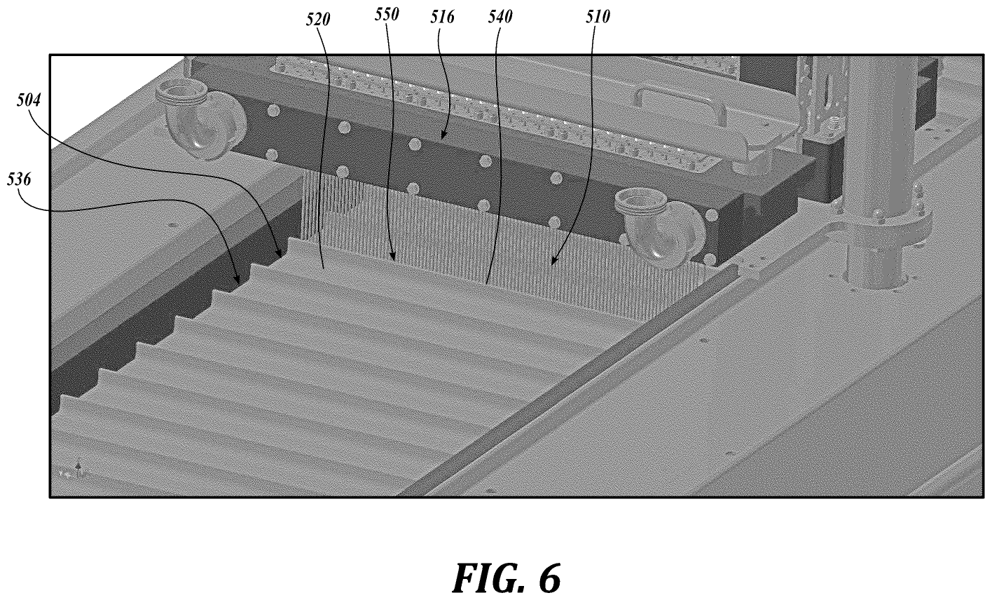

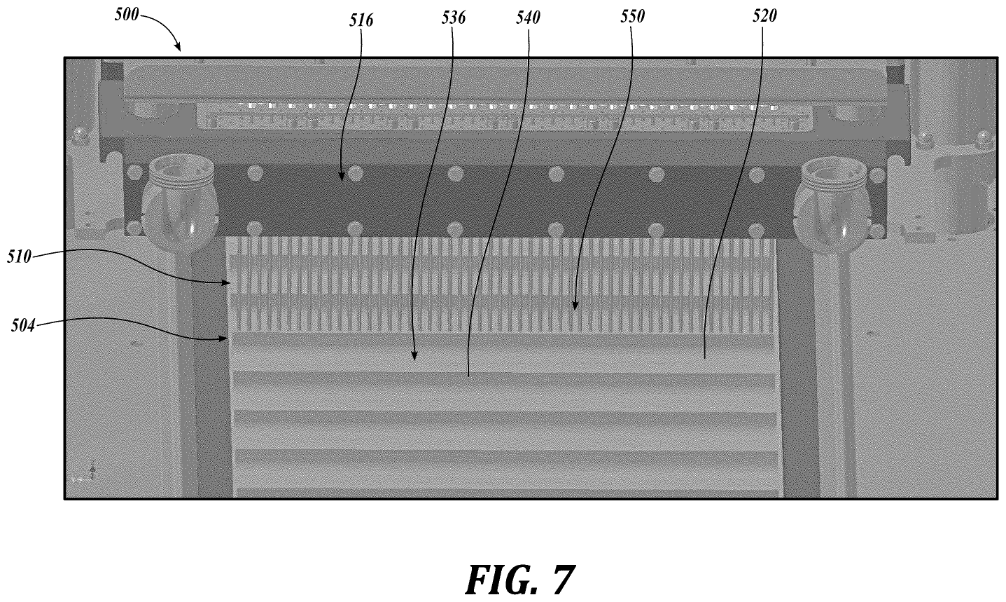

FIGS. 5-7 shows an alternative embodiment of an injection system for injecting crustaceans with the HVB injection treatment solution described herein or another suitable solution. Generally, the injector setup shown and described with respect to FIGS. 5-7 is configured to substantially maintain the position of the crustacean substrate relative to the conveyance system as it is conveyed, like the system described above with respect to FIG. 3. In that regard, parts like those described with respect to FIG. 3 will be labeled with similar reference numerals, except in the '500 series. Moreover, it should be appreciated that any of the components or features of the system shown in FIG. 3 may be used in the system described herein with respect to FIGS. 5-7.

The injection system shown partially in FIGS. 5-7 is generally configured as a dual head injector 500 that can inject stabilized crustaceans multiple times along their conveyance path through an injector. For instance, with the conveyance system 504 configured in the manner described herein, each head of the dual head injector 500 injects a batch of stabilized crustaceans as the crustaceans are conveyed downstream.

The dual head injector 500 may be any suitable automated or manual machine suitable for injecting crustaceans, such as shrimp, with the HVB injection treatment solutions described herein or another suitable solution. For instance, the dual head injector 500 may be a dual head IMAX injector from John Bean Technologies Corporation of Chicago, IL.

The dual head injector 500 includes a first injector head 516 and a second injector head 518 spaced along the length of the conveyance system 504. The first injector head 516 is located upstream from the second injector head 518 and is configured to inject crustaceans in a first instance when being conveyed by the 504. The second injector head 518 is configured to inject crustaceans in a second instance when being conveyed by the 504. In that regard, a single batch of crustaceans may be injected twice along their conveyance path through the dual head injector 500.

The first and second injector heads 516 and 518 support a plurality of injection needles 510, such as similar to that described above with reference to carrier 116. In that regard, the injection needles 510 may be arranged on each carrier 516 and 518 in any suitable manner to inject the crustacean with a desired amount of HVB injection treatment solution. In the case of shrimp, the plurality of injection needles 510 may be arranged in a generally tight cross-stitched pattern suitable for penetrating the shrimp when the shrimp are arranged in a random but generally spread-out manner on a support surface 520 of the conveyance system 504. In one specific example, the first and second injector heads 516 and 518 are configured as top port injector heads having a 2×300 needle arrangement. For larger crustaceans, such as lobster, a more spaced-out cross-stitch needle arrangement may be used.

Any suitable needle design may be used. For instance, an injection needle having an elongated shank and a hypodermic exit may be used. The injection needle may have an elongated shank with an upper portion of a first diameter that is larger than a second diameter of a lower portion. In one non-limiting example, the injection needle may have an upper portion that is about three millimeters in diameter that tapers down to a lower portion that is about 2.5 millimeters in diameter.

The crustacean substrates may be conveyed on the conveyance system 504 of the dual head injector 500 until they are positioned beneath one of the first and second carriers 516 and 518. The crustaceans are injected with HVB injection treatment solution by moving the respective carrier down towards the support surface 520 of the conveyance system 504 until the needles 510 penetrate the crustacean substrate at a suitable depth and for a suitable length of time to allow for the HVB injection treatment solution to be dispersed into the crustacean substrate.

As noted above, HVB injection treatment solution that is not picked up by the crustacean will generally overflow onto a support surface 520 of the conveyance system 504, wherein the support surface 520 may be configured as an endless conveyor belt comprised of rubber and/or plastic. In that regard, the support surface 520 will be hereinafter sometimes referred to as a “conveyor belt 520” or simply “belt 520”. The conveyor belt 520 may include through-holes, not shown, like those shown and described with respect to FIG. 2, to allow for drainage of treatment solution.

The conveyor belt 520 may also include a crustacean stabilizing assembly 536 configured to substantially maintain the shrimp or other crustaceans in their position relative to the belt as it is moved. In one example, the crustacean stabilizing assembly 536 includes a plurality of substrate-stabilizing features 540 that are engageable by the suspended crustaceans as the belt 520 accelerates or stops. For instance, the substrate-stabilizing features 540 of the crustacean stabilizing assembly 536 may be defined by a plurality of protrusions, partitions, flights, lips, etc. (hereinafter simply “lips”) protruding from the top surface of the belt body 522, at least some of which are transversely arranged relative to the elongated axis of the belt 520 and spaced relative to one another.

The substrate-stabilizing features 540 may be of a suitable height, shape, contour, etc., and they may be spaced along the elongated axis of the belt 520 a suitable distance to retain a desired number of crustaceans between adjacent substrate-stabilizing features 540 as the belt moves and the crustaceans are injected. For instance, as shown in FIGS. 5-7, the substrate-stabilizing features 540 may be a lip that extends substantially across the width of the belt 520 and extends substantially transversely upwardly from the belt upper surface to define a lip height that is substantially equal to or greater than a maximum height of crustacean when suspended in HVB injection treatment solution liquid.

The lips may be spaced apart a suitable distance to enable substantially all the needles 510 of a carrier to engage crustaceans between adjacent lips. For instance, the lips may be spaced along the elongated axis of the belt 520 a suitable distance to retain a desired number of crustaceans between adjacent protrusions for a partial advance of the belt beneath the injector. In that regard, a head and/or needle pattern of the injector may essentially fit inside a compartment or pocket defined on the belt between adjacent lips, and the injector can inject crustaceans in a pocket every time the belt advances. In this manner, the movement of the injector head and the belt are substantially synchronized.

In the example shown in FIGS. 5-7, the lips may be spaced along the elongated axis of the belt 520 a suitable distance to retain a desired number of crustaceans between adjacent protrusions for a partial advance of the belt beneath the injector. For instance, while running a half advance of the belt 520 or any other suitable belt indexing pattern, speed, etc., the first injector head 516 is configured to engage/inject a first batch of crustaceans in a first pocket 550 of the crustacean stabilizing assembly 536. After the first injector head 516 is withdrawn, the belt 520 is advanced, such as with a partial (e.g., half) advance, such that the first pocket 550 is located between the first injector head 516 and the second injector head 518. The first and second injector heads 516 and 518 are again lowered, and the first injector head 516 injects a second batch of crustaceans in a second pocket (not labeled) located upstream of the first pocket 550.

The first pocket 550 advances in sync with the downward and upward movement of the first and second injector heads 516 and 518 until it is positioned beneath the second injector head 518. The second injector head 518 then engages/injects the first batch of crustaceans in the first pocket 550. In that manner, the pockets defined by the crustacean stabilizing assembly 536 are sized and arranged on the belt 520 relative to the longitudinal position of the first and second injector heads 516 and 518 such that each batch of crustaceans is injected twice along its conveyance path through the dual head injector 500.

It should be appreciated that any other suitable arrangement of pockets, including their size, spacing, and position relative to the conveyance path location of the first and second injector heads 516 and 518 may be used to inject crustaceans within a pocket a suitable number of times with a desired number of injector heads.

### Exemplary Method for Injecting a Crustacean

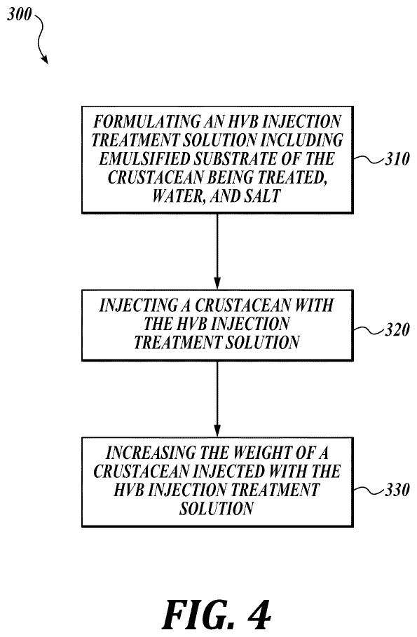

FIG. 4 illustrates an example method 400 for injecting a crustacean. The method 400 may be carried out using any of the aspects disclosed herein.

At step 410, the method may include formulating an HVB injection treatment solution including emulsified crustacean substrate of the crustacean being treated, water, and salt. The HVB injection treatment solution may be made in the manner described above. The percentages of each of the emulsified crustacean substrate of the crustacean being treated, water, and salt may be any of the percentages disclosed above. In some examples, the HVB injection treatment solution includes phosphate, such as when continued use of the same packaging/label containing the phosphate ingredient is needed.

The method may include conveying a crustacean on a conveyance system configured to substantially maintain the position of the crustacean relative to a support surface of the conveyance system before, during, and/or after injection. For instance, the conveyance system may include a belt design as described herein.

At step 420, the method may include injecting a crustacean with the HVB injection treatment solution. The crustacean may be injected such that the HVB injection treatment solution is in the amount of about 20-25% of the crustacean being injected.

At step 430, the method may include increasing the weight of a crustacean injected with the HVB injection treatment solution. For instance, the weight of the crustacean may increase after injection, after cook, and/or after freezing (such as using the IQF process).

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

Language such as “top”, “bottom”, “upper”, “lower”, “vertical”, “horizontal”, “lateral”, etc., in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, it may not be included or may be combined with other features.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term.

Likewise, the disclosure is not limited to various example examples given in this specification. Unless otherwise defined, technical and scientific terms used herein have the meaning as commonly understood by one of ordinary skill in the art to which this disclosure pertains. In the case of conflict, the present document, including definitions will control.

Note that titles or subtitles may be used in the examples for convenience of a reader, which in no way should limit the scope of the disclosure.

While illustrative examples have been illustrated and described, it will be appreciated that various changes can be made therein without departing from the spirit and scope of the disclosure.

What is claimed is:

1. A conveyance system for conveying a crustacean to be injected with an injection treatment solution made from water and emulsified crustacean substrate of the crustacean being treated, the conveyance system comprising:
a crustacean stabilizing assembly configured to substantially maintain a position of crustaceans relative to a support surface of the conveyance system before, during, and/or after injection,
wherein a first pocket defined by the crustacean stabilizing assembly is positionable beneath a first injector head, the crustacean stabilizing assembly supporting crustaceans in the first pocket during injection by the first injector head, and
wherein the first pocket defined by the crustacean stabilizing assembly is positionable beneath a second injector head located downstream of the first injector head, the crustacean stabilizing assembly supporting crustaceans in the first pocket during injection by the second injector head.

2. The conveyance system of claim 1, wherein the first pocket advances in sync with downward and upward movement of the first and second injector heads such that it is positionable beneath the first and second injector heads for injection.

3. The conveyance system of claim 1, wherein the first pocket is defined by first and second lips protruding upwardly from the support surface of the conveyance system that are of a height that is substantially equal to or greater than a maximum height of crustaceans when suspended in injection treatment solution liquid on the support surface.

4. A method of injecting shrimp, comprising:
positioning crustaceans within a first pocket of a crustacean stabilizing assembly defined on a support surface of an injector conveyance system;
advancing the support surface to locate the first pocket beneath a first injector head of the injector;
injecting the crustaceans positioned in the first pocket with the first injector head;
advancing the support surface to locate the first pocket beneath a second injector head of the injector that is downstream of the first injector; and
injecting the crustaceans positioned in the first pocket with the second injector head.

5. The method of claim 4, further comprising advancing the support surface to locate the first pocket beneath a portion of the injector located between the first injector head and the second injector head while injecting crustaceans located in a second pocket located upstream of the first injector.

6. The method of claim 4, further comprising formulating an injection treatment solution for the injection, comprising:
water;
salt, wherein an amount of salt is between about.1-3% of the injection treatment solution; and
emulsified shrimp meat, wherein an amount of emulsified shrimp meat is between about 10-25% of the injection treatment solution;
injecting shrimp with the injection treatment solution;
increasing a pre-injection weight of shrimp injected with the injection treatment solution by greater than about 18%.
